(19) United States
(12) Patent Application Publication
(10) Pub. No.: US 2010/0322427 A1
(43) Pub. Date: Dec. 23, 2010

(54) METHOD FOR MANAGING ENCRYPTION KEYS IN A COMMUNICATION NETWORK

(75) Inventor: Marc Smaak, Bergen op Zoom (NL)

Correspondence Address: MICHAEL J. STRIKER, 103 EAST NECK ROAD, HUNTINGTON, NY, 11743, US

(73) Assignee: ROBERT BOSCH GMCH, STUTTGART (DE)

(21) Appl. No.: 12/867,071

(22) PCT Filed: Mar. 31, 2008
(86) PCT No.: PCT/EP08/53796

§ 371 Date: Aug. 11, 2010

(51) Int. Cl. H04L 9/00

(52) U.S. Cl. 380/277

(57) ABSTRACT

The invention provides for a method for managing encryption keys in a communication network (10) comprising at least one transmitter (14) and at least one receiver (16, 18, 20, 22), wherein the receiver (16, 18, 20, 22) has access to at least one encryption key, wherein the validity of the key is determined within the receiver. Furthermore, the invention provides for a receiver (16, 18, 20, 22), a communication network (10), and a computer program for performing the described method.

### TECHNICAL FIELD

The invention provides for a method for managing encryption keys in a communication network, a communication network, a receiver for use in this communication system, and a computer program for performing said method.

### BACKGROUND ART

In communication networks data is transferred between members of this network, namely the transmitters and/or receivers of messages and information transmitted. In today's networks data security is an important issue as members of the network must rely in the validity of received data and confidential information must be protected against unauthorized access.

Since the available bandwidth is limited a proper system design should use the available bandwidth in an efficient way. In case a transmitter wants to send the same information to multiple receivers, it is better to use multicast traffic (one to many) rather than uni-cast (one to one). If necessary, such a multicast data stream can be encrypted. This requires all receivers to have the same key to decrypt the data.

It should be noted that having one key for a large number of receivers increases the risk that this key will be obtained by a malicious person who can from that moment on receive and decrypt the multicast data stream. Frequent key changes are a known manner to avoid this. This is called rotating keys.

Furthermore, multicasting is often used for streaming media (audio and/or video) signals. Using such signals you have to send data in a very regular manner without interruption. Therefore, corrupted data will immediately lead to a problem at the receiving site.

As a result, additional requirements for updating the encryption key on a running stream exist. For example, all receivers should switch to the new key at exactly the same time. This moment needs to be known by the transmitter and all receivers of the stream. Especially, in case that distribution of the new key is not embedded in the streaming media data itself but is transmitted via a secondary path. This can be a multicast but also a uni-cast transmission with a separate encryption per receiver to further increase the security level.

Therefore, it will be difficult for the receiver to know the exact moment required to switch the streaming media decryption key. Hence the receiver will not notice the use of the wrong (outdated or future key) but will simply decode the data using the inappropriate key and therefore will obtain useless data.

It should be noted that timing is an important factor in all audio and video systems. In such applications it is important that all receivers run exactly synchronous. Special mechanisms are required to realize this over asynchronous networks.

### DISCLOSURE OF THE INVENTION

According to a method for managing encryption keys in a communication network comprising at least one transmitter and at least one receiver, the receiver has access to at least one encryption key and the validity of the key is determined within the receiver.

According to an embodiment a time when the encryption key is valid is sent to the receiver and the validity of the key is determined based on this time.

The key and the corresponding time can be sent by the transmitter, preferably separate to the key.

In a possible embodiment the method uses a master clock in the network and distributes this master clock to all other networked nodes. This results in a system that has an equal time reference throughout all networked nodes. Using this the transmitter can choose a time in the future when it will perform an update and use a new encryption key. The new key is first distributed to all receivers of the multicast stream via a secure connection. Furthermore, the time this key will become valid is announced. Since receivers have exactly the same time reference they will be able to switch at the correct moment. The switch to a new encryption key will be performed throughout all receivers without any data loss. This is especially a solution for standard Ethernet IP networks.

According to another embodiment, the method for managing encryption keys in a communication network comprising at least one transmitter and at least one receiver, wherein the receiver has access to at least a first encryption key and a second encryption key, comprises the following steps: decrypting received data using the first encryption key, decrypting received data using the second encryption key, and evaluating which decryption was successful. The invalid decrypted data can be discarded. Only the data obtained by the successful decryption is sent out. When a new encryption key is received the oldest has to be deleted.

Alternatively, the method comprises the following steps: decrypting received data using the first encryption key, evaluating if decryption was successful, and in case that the decryption was not successful, start using the second encryption key.

Start using the second encryption key means that the data received is again decrypted by the second key. Alternatively, the decrypted data can be discarded and the second key will be used for decrypting data received in the future.

The embodiment, wherein the received data is always decrypted with both keys, is faster but needs more resources.

In an embodiment the evaluation of the decryption is performed by validating the decrypted data. This validation can performed based on a valid data header, e.g. a TCP/UDP checksum.

The first encryption key and the second encryption key and possibly further encryption keys can be stored in the receiver. For this purpose, the receiver can comprise a storage element, e.g. an electronic semiconductor storage element. This storage element can be divided in segments for the keys.

In a possible embodiment at least the second encryption key is sent by the transmitter transmitting the corresponding data. This key or all the keys can be distributed via a separate secure connection. Generally, the transmitter sending the encrypted data is also transmitting the corresponding encryption key.

Furthermore, a receiver employed in a communication network adapted to perform a method according to one of claims 1 to 8 is provided.

This receiver can have access to at least a first encryption key and a second encryption key and comprises a computing unit adapted for decrypting encrypted received data and evaluating the decryption. If the evaluation shows that the used encryption key is invalid the receiver is adapted to take a new key for decryption in the future.

The receiver can comprise a storage element in which the first and the second encryption keys are stored. Of course more than two encryption keys can be stored in the storage element. Outdated keys can be discarded or stored for use in the future. The keys within the storage element can be organized according to the order of use.

A communication network comprises at least one transmitter and at least one receiver mentioned above. This communication network can be used in audio and video systems sending the data via wire or wireless. Furthermore, this communication network can be a multicast or a uni-cast network with a separate encryption per receiver. In this communication network a synchronous or an asynchronous encryption/decryption method can be used.

A computer program comprises program coding means for carrying out all the steps of a method according to one of claims 1 to 8, when the computer program is run on a computer or a corresponding computing unit.

The coding means can be stored on a computer-readable data carrier for carrying out all the steps of a process according to one of claims 1 to 8, when the computer program is run on a computer or a corresponding computing unit.

Therefore, the invention provides for a method to update encryption keys in the transmitter at a specific moment and indirectly inform all receivers about this specific moment.

If it is possible to detect that the decryption of a data packed was successful at the receiving side, it is not necessary to distribute a time when the new key is valid. In this case the receiver needs to have the new key on time and will start using it as soon as soon as packets decrypted with the old key are not valid anymore.

The evaluation of the decryption process can be performed based upon a valid packet header, e.g. a TCP/UDP checksum. However, it should be noted that the mechanism without the valid time indication and the single decryption method using the first and the second key could lead to additional data loss in case of corrupted packets. If a corrupted packet is received after the moment the new key is received but before it has to be actually used all packets until the right key switch moment will get corrupted (decrypted with the wrong key). This will result in a longer corruption of the media stream than based upon the actual corrupted data. This problem can be solved by always decrypting in parallel with the first and the second key.

All in all, the invention at least in the embodiments provides for a way to guarantee the reliability of data transmitted in a communication network, especially in a audio or video system. It is not necessary to send timepoints of change making the entire method less complicated and more efficient.

Further features and embodiments of the invention will become apparent from the description and the accompanying drawings.

It will be understood that the features mentioned above and those described hereinafter can be used not only in the combination specified but also in other combinations or on their own, without departing from the scope of the present invention.

The invention is diagrammatically illustrated in the drawings by means of embodiments by way of example and is hereinafter explained in detail with reference to the drawings. It is understood that the description is in no way limiting on the scope of the present invention and is merely an illustration of embodiments of the invention.

### BRIEF DESCRIPTION OF THE DRAWINGS

FIG. 1 diagrammatically shows a communication network for performing the described method.

FIG. 2 diagrammatically shows a possible embodiment of a receiver used in a communication network as shown in FIG. 1.

### DESCRIPTION OF EMBODIMENTS

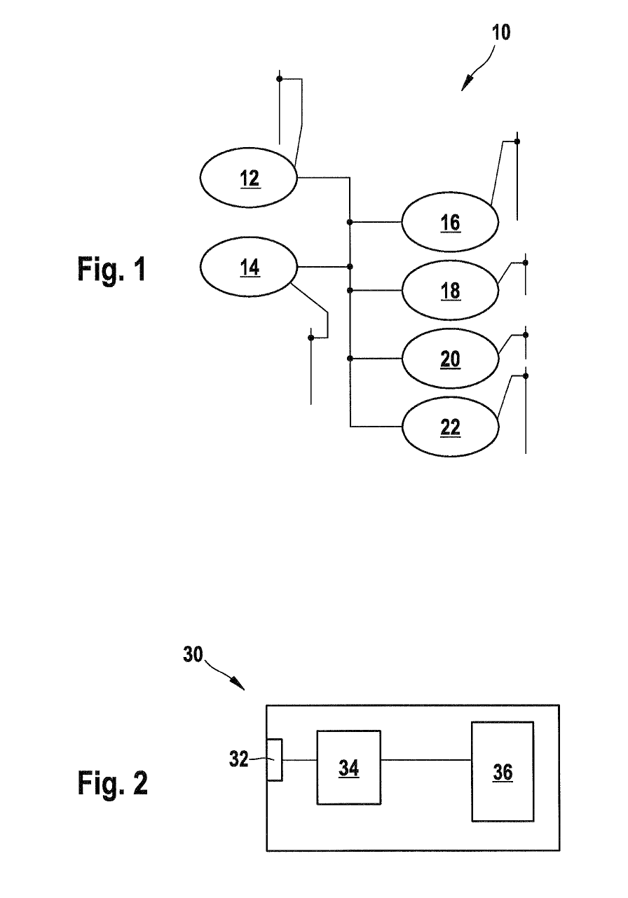

According to FIG. 1 a communication network generally designated with reference number 10 comprises a timing master 12, a multicast transmitter 14, a first multicast receiver 16, a second multicast receiver 18, a third multicast receiver 20, and a third multicast receiver 22. The transmitter 12 distributes a first and a second key to all receivers 16, 18, 20, and 22.

The transmitter 12 sends encrypted data using a first key to all the receivers 16, 18, 20, and 22 which use a corresponding first key for decryption. At a certain point of time the transmitter 12 starts sending data encrypted by a second encryption key. The receivers 16, 18, 20, and 22 trying to decrypt the data with the first key notice that the decryption was not successful and start to use a second decryption key appropriate to decrypt the data.

Alternatively, the receivers decrypt in parallel with an old and a new key. Therefore, it is possible to detect at the receiving side that the decryption of a data packet was successful. It is not necessary to distribute a time when the new key is valid. The receivers 16, 18, 20, and 22 can always decode the received data with the new and the old key.

According to a further embodiment, the timing master 10 announces the current time to all networked noted, i.e. the transmitter 14 and the receivers 16, 18, 20, and 22. In this case the multicast transmitter 12 announces at time 12345 that the new key hast to be used beginning with time 123400. Due to different network delays the receivers 16, 18, 20, and 22 receive this information at different times, e.g. at 12346 and 12348. However, all receivers 16, 18, 20 and 22 will switch to the new key at 12400 without data loss.

FIG. 2 shows an embodiment of a receiver 30 for use in a communication network as shown in FIG. 1. The receiver 30 comprises an interface 32 for receiving data and possibly encryption keys sent via the communication network. Furthermore, the receiver 30 comprises a computing unit 34 and a storage element 36.

The computing unit 34 performs the decryption and evaluates this decryption process. The storage element 36 contains a number of encryption keys accessible for the computing unit 34.

1. Method for managing encryption keys in a communication network (10) comprising at least one transmitter (14) and at least one receiver (16, 18, 20, 22, 30), wherein the receiver (16, 18, 20, 22, 30) has access to at least one encryption key and the validity of the key is determined within the receiver (16, 18, 20, 22, 30).

2. Method for managing encryption keys in a communication network (10) according to claim 1, wherein a time when the encryption key is valid is sent to the receiver (16, 18, 20, 22, 30) and the validity of the key is determined based on this time.

3. Method for managing encryption keys in a communication network (10) according to claim 2, wherein the key and the corresponding time is sent by the transmitter (14).

4. Method for managing encryption keys in a communication network (10) according to claim 1, wherein the receiver (16, 18, 20, 22, 30) has access to at least a first encryption key and a second encryption key, comprising following steps:
decrypting received data using the first encryption key,
decrypting received data using the second encryption key,
evaluating which decryption was successful.

5. Method for managing encryption keys in a communication network (10) according to claim 4, wherein the evaluation of the decryption is performed by validating the decrypted data.

6. Method according to claim 5, wherein the validating is performed based on a valid data header.

7. Method according to claim 4, wherein the first encryption key and the second encryption key are stored in the receiver (16, 18, 20, 22, 30).

8. Method according to claim 4, wherein at least the second encryption key is sent by the transmitter (14) transmitting the corresponding data.

9. Receiver employed in a communication network adapted to perform a method according to claim 1.

10. Communication network comprising at least one transmitter (14) and at least one receiver (16, 18, 20, 22, 30) according to claim 9.

11. Computer program with program coding means, for carrying out all the steps of a process according to claim 1, when the computer program is run on a computer or a corresponding computing unit (36).

12. Computer program with program coding means which are stored on a computer-readable data carrier, for carrying out all the steps of a process according to claim 1, when the computer program is run on a computer or a corresponding computing unit (36).
